(19) United States
(12) Patent Application Publication
(10) Pub. No.: US 2015/0230050 A1
(43) Pub. Date: Aug. 13, 2015

(54) Communication Network Aggregating Local Geolocation Information

(71) Applicant: SOLOMO IDENTITY, LLC., MADISON, WI (US)

(72) Inventors: Joe Barneson, MADISON, WI (US); CHRISTOPHER W. KELLY, MADISON, WI (US); ELIZABETH EVERSOLL, VERONA, WI (US); JENNIFER WEIS, HUBERTUS, WI (US)

(21) Appl. No.: 14/619,943

(22) Filed: Feb. 11, 2015

Related U.S. Application Data
(60) Provisional application No. 61/938,396, filed on Feb. 11, 2014.

(51) Int. Cl. H04W 4/02

(52) U.S. Cl. CPC H04W 4/02

(57) ABSTRACT

A geolocation aggregator provides a database collecting information about different geolocation venues and zones linked to context information. Campaigns may provide content to individuals within the zones according to a matching between desired context information and the context information at the zones permitting a more comprehensive delivery of geolocation services among different venues.

### CROSS REFERENCE TO RELATED APPLICATION

This application claims the benefit of U.S. provisional application 61/938,396 filed Feb. 11, 2014, and hereby incorporated by reference.

### BACKGROUND OF THE INVENTION

The present invention relates to geolocation systems for identifying the users of mobile transmitters such as cell phones within the venue, and in particular, to a communication network that allows focused delivery of information to individuals located among many disparate, local geolocation systems.

Geolocation systems allow approximate tracking of the location of mobile wireless devices in an indoor environment or any location where GPS signals are unavailable or weak. Such systems may be used, for example, to locate critical personnel (such as medical personnel in a hospital or airline workers in an airport) or may be used to provide additional services to consumers in a retail environment including navigation or localized promotions such as coupons.

Geolocation can be implemented using the same short-range wireless access points and routers used to establish a local area wireless network communicating with such mobile wireless devices, for example, using the IEEE 802.11 standard. By measuring the signal strength, signal phase and/or reception angle of wireless data communicated between a mobile wireless device and multiple access points, the location of the mobile wireless device may be established by multilateration or multiiangulation, or other interpolated techniques (henceforth, collectively, signal-based location).

Geolocation can be used by the managers of different venues to locate patrons and to provide communication to patrons in those venues based on the deduced location of the patrons and “context knowledge” about the patron's location. For example, that the location is the men's department of the venue of a department store. Generally context data goes beyond information defining spatial location of the venue to capture information about the venue environment. This additional context knowledge, for example, can be used by a retailer to provide promotional coupons or other information to a consumer based on an interest of the consumer inferred from the consumer's location.

Geolocation promotion is practically limited to relatively large entities that can have significant promotional material that can justify the necessary investment in the infrastructure of the geolocation system for delivering communications.

### SUMMARY OF THE INVENTION

The present invention provides a method of aggregating multiple disparate and generally independent geolocation systems that might otherwise be incompatible and providing content delivery, for example, promotional material, from multiple vendors possibly unrelated to the entities owning or controlling the venue. In this way, the services provided by geolocation can be greatly expanded.

Important to this aggregation is a method of making the geolocation systems broadly compatible through a tagging of locations with readily interpreted context knowledge and by establishing a system of permissions that include both the individual in the geolocation venue and the owner of the geolocation venue fundamental to this aggregation process. A revenue-sharing mechanism may be used to help offset the investment in geolocation infrastructure.

In one embodiment, the invention provides a system for delivering location-specific information and includes a multiplicity of spatially separated venues each presenting at least one zone through which individuals may travel with a geolocation system in each venue for tracking and communicating with wireless devices held by the individual and identifying a zone in which the individual is traveling. A database provides identifying linked venues and zones and contexts, the contexts describing an environment of the zones and a content server communicates with the database to: (1) receive content suitable for individuals in the venues; (2) receive campaigns linked to the content indicating desired contexts for the delivery of the content; (3) matching those campaigns to venues and zones according to corresponding desired contexts and the context of the zones to identify zones; and (4) delivering the content selectively to individuals in the identified zones.

It is thus a feature of at least one embodiment of the invention to provide a way of linking otherwise isolated geolocation systems through a mechanism allowing automatic searches for desired venue contexts for the delivery of services and information to customers.

The database may further identify linked zones and individuals and provide individual descriptors about the individuals and linked to the individuals. The campaigns may further link content to desired individual descriptors of individuals for the delivery of the content and the matching may match the campaigns to venues and zones according to the desired individual descriptors and individual descriptors of the individuals within the zones.

It is thus a feature of at least one embodiment of the invention to permit focused delivery of content to individuals based both on the individuals themselves and the venues in which they are located.

The geolocation system may update the database with respect to linking individuals to zones by tracking and communicating with wireless devices held by the individual and identifying a zone in which the individual is traveling.

It is thus a feature of at least one embodiment of the invention to provide a searching system that can accommodate the highly dynamic data of moving individuals to provide content delivery that is relevant to the current location of the consumer over a broad set of venues.

The content server may analyze individual descriptors of individuals in given zones to augment the context information for the zones based on a historical aggravation of individual descriptors of individuals within given zones.

It is thus a feature of at least one embodiment of the invention to provide a form of automatic tagging of venues and zones with context information based on known information about the individuals visiting those zones. It is a further feature of at least one embodiment of the invention to provide for tags that reflect the context of the zones through the type of individuals attracted to the zones.

The database may include individual permissions linked to the individuals describing each individual's preferences with regard to sharing of the individual descriptors and wherein the matching of campaigns to venues and zones is limited according to the individual permissions.

It is thus a feature of at least one embodiment of the invention to provide consumers with a robust set of protections for their personal information such as may encourage free sharing of that information when it is advantageous to the consumer.

The individual permissions may include restrictions on a frequency of delivery and form of delivery of content.

It is thus a feature of at least one embodiment of the invention to greatly expand the pool of potential individuals who may receive relevant content without the risk of abusing permissions granted by the consumers to receive this data.

The database may include venue permissions linked to the venues describing each venue's preferences with regard to the delivery of content and wherein the matching of campaigns to venues and zones is limited according to the venue permissions.

It is thus a feature of at least one embodiment of the invention to encourage participation of venues by ensuring control by the venue of the experience offered to consumers within the venue as may be affected by the delivery of content.

The database may further provide a listing of entities controlling the zones and the content server may provide a payment credit to the entities of the identified zones upon delivery of content selectively to individuals in the identified zones.

It is thus a feature of at least one embodiment of the invention to provide for a financial incentive for individuals to construct and maintain geolocation delivery infrastructure.

These particular objects and advantages may apply to only some embodiments falling within the claims and thus do not define the scope of the invention.

### BRIEF DESCRIPTION OF THE FIGURES

FIG. 1 is a simplified plan view of multiple venues, for example, stores, communicating with an aggregating content server and showing the division of one venue into multiple zones;

FIG. 2 is a simplified diagram of a database of the aggregating content server in which zones are tagged with keywords allowing searching across multiple venues and multiple zones,

FIG. 3 is a data flow diagram showing a multilevel permission structure allowing the sharing of geolocation information among patrons and venues; and

FIG. 4 is a data flow diagram showing delivery of content authorized by the permission structure and using the keyword tags.

### DETAILED DESCRIPTION OF THE PREFERRED EMBODIMENT

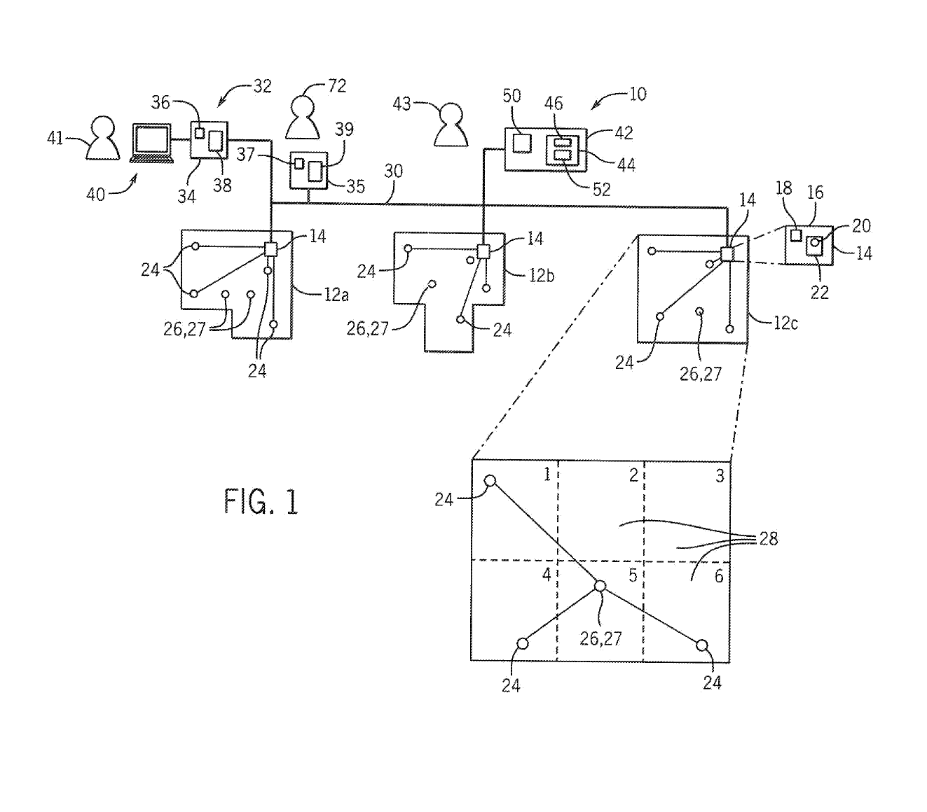

Referring now to FIG. 1, a global geolocation communication system 10 may work with multiple venues 12a-12c, for example, stores, sports arenas, or institutions such as hospitals libraries and the like.

Each of the venues 12 may have a network portal 14 generally providing for a computer 16 with a processor 18 executing a stored program 20 held in a memory 22. Each network portal 14 may also provide network interface capabilities and may communicate with multiple wireless transceivers 24 distributed in the venue 12. These wireless transceivers 24 provide for communication with mobile devices 26 (such as cell phones) held by individuals 27 within the venues 12. As is generally understood in the art, such mobile devices 26 also provide wireless transceivers and processors that may execute stored programs held in internal memory.

The network portals 14 may include geolocation abilities so as to determine the location of the mobile devices 26 through triangulation or the like. Geolocation systems suitable for use with the present invention are described in U.S. patent application Ser. No. 13/959,908 filed Aug. 6, 2013, and U.S. application Ser. No. 14/030,042 filed Sep. 18, 2013, assigned to the assignee of the present application and hereby incorporated by reference.

The invention contemplates that other methods of geolocation may be employed than triangulation, for example, a retransmission by the mobile device 26 of a locally received radio beacon, for example, a Bluetooth low energy beacon, placed on product shelves or the like. Each beacon forms a small zone of transmission around it that enables the location of the receiving mobile device 26 to be located.

The geolocation systems may establish the location of the mobile devices 26 at one or more points of interest or in one or more predefined zones 28 in each venue 12, for example, the zones 28 representing departments of a store, service areas of an institution, or other logical divisions related to the context of the zone 28. The zones 28 may be tailored to the particular venue, for example, by establishing spatial ranges for the desired zone 28 and assigning geolocation coordinates of a mobile device 26 to a zone 28 according to whether the geolocation coordinates of that device lie within the spatial range.

Each venue 12 may be associated with a computer system 35 also having a processor 37 and memory 39 and associated with the managing entity 72 of that venue 12. The computer 35 may manage a venue information locker and high-level communication with the mobile devices 26.

Referring still to FIG. 1, each of the network portals 14 may communicate via a global network 30, for example, the Internet, with content provider 41, the latter using network terminals 32 being, for example, network connected computers 34 having a processor 36 and a memory 38 holding a stored program and having user interface devices 40 such as a terminal, keyboard, mouse or the like. The global network 30 also communicates with an aggregating content server 42 providing a memory 44 holding a stored content server program 46 that may be executed by one or more processors 50 and a database 52 as will be described.

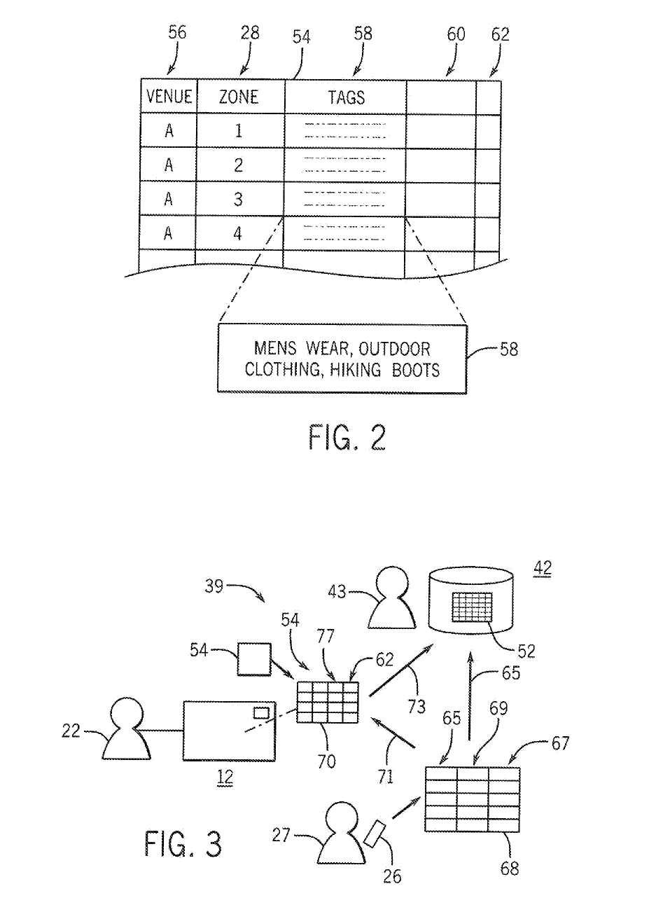

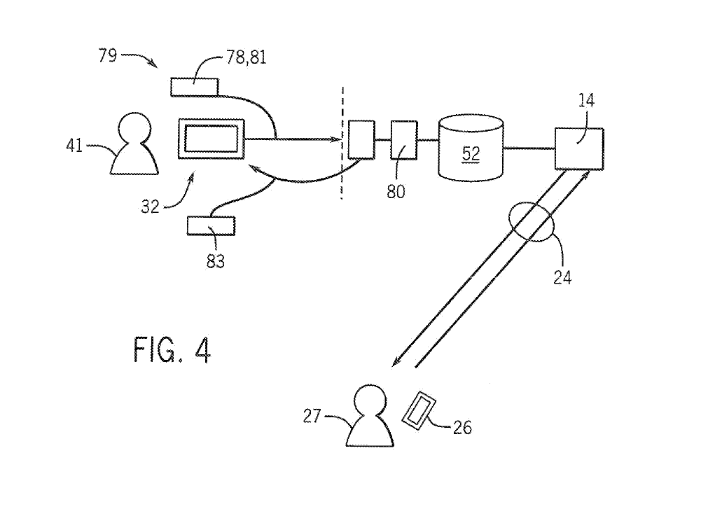

Referring now to FIG. 2, each of the zones of FIG. 1 for each of the venues 12 may be tagged in a tag table 54 associated with but not necessarily located in the aggregating content server 42. The tag table 54 provides multiple entries (depicted as rows), each identified to a venue identifier 74 typically identifying a managing entity 72 (represented in FIG. 3) owning, controlling, or managing a given venue 12 (henceforth the “managing entity”) and providing attributes (columns) defining multiple zones 28 of that venue 12 as linked to tags 58.

As noted above, the tags 58 provide context knowledge about the zone 28, for example, describing the services, products, or purpose of the zone 28 within the venue 12. For example, a menswear department zone 28 may be tagged with the word “men's wear” as well as additional tags such as “outdoor clothing”, “hiking boots” or the like. Multiple tags 58 are generally preferred for each zone 28 which describe different dimensions of the significance of the zone 28, for example, of increasing detail or alternate overlapping categories. In one embodiment, the tags 58 may be selected from a standard dictionary of predefined tags although the invention contemplates that the tags 58 may be constructed of free-form text entered by the managing entity 72.

Each entry may also provide additional venue data 60 that may vary for a given venue of multiple venues associated with a given managing entity 72. For example, the additional venue data 60 may include a geographic location of the venue 12, a general description of the venue type and data links related to the location of the entity, for example, the demographics of the neighborhood or the like, in which the venue 12 is located. In addition, the tag table 54 may provide for permission information 62 as will be discussed.

Logically the tag table 54 will be associated with each venue 12 and will be aggregated with other tag tables 54 at database 52 of the aggregating content server 42, but the actual data may be physically located anywhere, for example, in distributed fashion in the network portals 14 or elsewhere in communication with the global network 30. The tag table 54 may equally be associated with different retailers, brands or products.

Referring now to FIG. 3, an individual 27 within the venue 12 may run a permission application on their mobile device 26 establishing a personal information locker 68 (typically including remote storage accessible over the Internet) holding individual descriptors 67 about the individual 27 linked to individual permissions 69 for sharing the data of the individual descriptors 67 with various entities. Individual descriptors 67 generally include personal information about the individual 27, for example: gender, age, associations and purchasing preferences but may also include information about locations (venues 12) that the individual has previously visited.

A personal information locker system for authorizing the sharing of consumer data with a given entity, as is usable with the present invention, is described in U.S. patent application Ser. No. 13/683,041 filed Nov. 21, 2012, and U.S. application Ser. No. 13/683,566 filed Nov. 21, 2012, both assigned to the assignee of the present application and hereby incorporated by reference.

The personal information locker 68 allows the individual 27 to freely manage any and all individual descriptors 67 that are to be shared with others and to independently manage permission levels for the use of the individual descriptors 67 and in some embodiments to revoke permission after granted, if desired. In particular, individual permissions 69 may be granted to an aggregator 43, for example, operating the aggregating content server 42 to make use of information about the individual 27 as will be discussed. Separate permissions may be granted to individual venues 12 or their managing entities 72. Example individual permissions 69 may provide limitations on the use of any or all individual descriptors 67 of the individual 27; limitations on the manner of use of the individual descriptors 67, for example, with or without aggregation with other data; time limits on the use of the individual descriptors 67; purposes of the use of the individual descriptors 67, for example, limited to offers or information only; and limitations on quality and frequency and form of contact with the individual 27 related to such offers or information.

The venue 12 may also be associated with a venue information locker 70 held in the computer 35 (shown in FIG. 1) operating in a manner similar to the personal information locker 68 but under control by the managing entity 72. The venue information locker 70 may hold the information of the tag table 54 of the venue 12 including information of the tags 58 in addition to geolocation information 77 indicating which individuals 27 are in the venue 12 at a current time. This latter geolocation information 77 will be limited by the extent that individuals 27 have agreed to share this geolocation information 77 with the venue 12 as defined in the personal information locker 68. These permissions maybe communicated directly or indirectly between the venue information locker and the mobile device 26 of the individual 27 as indicated by arrow 71.

The venue information locker 70 also holds venue permission rules 62 indicating the extent to which the managing entity 72 is willing to share venue information with the aggregator 43 and to have the aggregator 43 contact individuals 27 within the venue 12. In particular, the venue permission rules 62 may limit a number of contacts with individuals 27 in a given time and the type of content delivered to the individuals 27 (for example, excluding offers by competitors or materials that are likely to detract from the experience by the individuals 27 in the environment of the venue 12). This information may be incorporated directly or logically into the database 52 as indicated by arrow 73. Any conflicts between the individual permissions 69 and the venue permission rules 62 with respect to providing individual descriptors 67 on the individuals 27 is determined by the individual permissions 69 of the personal information locker 68.

In one embodiment, individual permissions 69 of the personal information locker 68 may be relayed through the venue information locker 70 to the aggregating content server 42, or a link may be provided (for example, an anonymous linking identification number) allowing the aggregating content server 42 to communicate with the personal information locker 68 to obtain the individual permissions 69 and the associated individual descriptors 67 as indicated by arrow 65.

All of the data to be shared with the aggregator 43 may be logically collected in the permission database 52 even though it may be held in spatially separate locations and thus the database 52 will generally include information from multiple managing entities, multiple venues 12, and multiple individuals 27.

The database 52 allows content to be delivered to many individuals 27 across a wide variety of different venues 12 and in this respect provides a richer source of content delivery to the content provider 41 (not just from a single venue 12 or managing entity 72) and allows better utilization of the geolocation infrastructure of a given venue 12 by opening it up to content from other entities.

In this regard, the global geolocation communication system 10 may operate by receiving generalized campaigns 79 from a content provider 41, the campaign 79 including specific content 81 to be delivered to the individual 27, for example, information or offers, and target information 78. The target information 75, for example, may describe desired individuals 27 to receive the content 81 identified by particular venues 12 matching target venue context (for example, from table 54) for venues 12 and desired individual descriptors 67 of the individuals 27 to whom the content 81 will be delivered. For example, the target information 78 may indicate a preference to deliver content to men between the ages of 20 and 30 who are in a menswear zone 28 of the venue 12. The content 81, for example, could be promotional coupons for men's ties and the targeting information could be tags 58 such as “men's department”, menswear”, “ties” or the like. Generally, the target information 78 may include sophisticated rules to combine data about the venues and individuals such as: men on their 5th visit, anyone in the venue 12 for over 30 min, etc. Some of this underlying data will be originally stored in the personal information locker 68 (for example the duration of the individual's stay in the venue 12).

These tags 58 may be developed independently by the content provider 41 or interactively by receiving example terms 83 from a concordance collecting the tags 58 of multiple tables 54. In addition or alternatively, tags 58 may be augmented at anytime by the program of the aggregating content server 42, for example, to include anonymized individual descriptors 67 of individuals 27 that have historically frequented the zone 28. In this way, a deeper knowledge of the type of individuals in a given zone 28 may be determined, and tags 58 may be generated automatically and the tags 58 may be used to identify the human environment of the venue 12.

A campaign 79 formed of the content 81 and target information 78 may be next provided to a synonym table 80 expanding the query words of the desired tags 58 to better include synonyms which may have been used in the development of tags 58 among the many venues 12. The synonyms may then be applied to the database 52 using conventional search techniques for each of the zones 28 of each of the tables 54 incorporated into the database 52. The results, identifying particular individuals 27 in various zones 28, may be weighted using techniques such as a term frequency-inverse document weighted search where the document is effectively the context information of a zone 28 of a venue 12 and the individual descriptors 67 of individuals 27 in the zone. In this way, particular individuals 27 in particular venues 12 may be identified for delivery of the content 81. This search is roughly analogous to a webpage search in which each of the zones 28 and its individuals 27 are converted to an effective webpage and promotional material delivered to the webpage (in this case the user's mobile device 26) in a particular zone.

In the event that there are multiple campaigns 79 that identify the same individuals 27 and there is a limitation on the amount of content 81 that may be delivered to the individuals 27, selected of the multiple campaigns 79 may be chosen according to a variety of techniques including a round-robin system, the campaign 79 that has the highest match with its target information 78, or randomly. Any individual campaign 79 may be rejected for a given individual 27 based on the permissions 69 associated with that individual 27.

This intended content 81 and any response by the individual 27 may be communicated through the wireless transceivers 24 and the network portal 14 in a particular zone 28 as routed to those devices using the entity information 56 of the tables 54, also revealed in the search, which provides network address transmit data from one of the wireless transceivers 24.

In the manner of conventional advertising delivery on the Internet, the content provider 41 may pay a fee for the delivery of promotional materials either viewed or responded to, and this fee may be shared among the various managing entities and the aggregator 43 operating the aggregating content server 42. In this way the managing entities are encouraged to open their geolocation information, with permission, to the aggregator 43.

It will be appreciated that the opportunity to communicate with an individual 27 identified by the permission-granted database 52 may be subject to bidding among different content providers 41 in the same way that is currently conducted on the Internet or other brokerage systems to allocate the scarce channel resources.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

While the present invention contemplates use with mobile devices that are cell phones or personal digital assistants, it will be appreciated that other consumer born transmitters may also work with the present invention including for example BLE/iBeacon which are small transmitters of Bluetooth MAC addresses, RFID transmitters, active or passive transmission of WiFi MAC address and general transmitters of audio or visual information that can be detected by sensors to establish location or location context. These devices may be directly carried by a consumer or in an article carried or moved by the consumer such as a shopping bag or shopping cart.

References to “a microprocessor” and “a processor” or “the microprocessor” and “the processor,” can be understood depending on context to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What is claimed is:

1. A system for delivering location specific information to an individual comprising:
a multiplicity of spatially separated venues each presenting at least one zone through which individuals may travel;
a geolocation system in each venue for tracking and communicating with wireless devices held by the individual and identifying a zone in which the individual is traveling;
a database providing identifying linked zones and contexts, the contexts describing an environment of the zones; and
a content server communicating with the database to:
(1) receive content suitable for individuals in the venues;
(2) receive campaigns linked to the content indicating desired contexts for a delivery of the content;
(3) match those campaigns to venues and zones according to corresponding desired contexts and context of the zones to identify zones; and
(4) deliver the content selectively to individuals in the identified zones.

2. The system of claim 1 wherein the database further identifies linked zones and individuals and provides individual descriptors about the individuals and linked to the individuals, and wherein the campaigns further link content to desired individual descriptors of individuals for the delivery of the content and wherein the matching matches the campaigns to venues and zones according to the desired individual descriptors and individual descriptors of the individuals within the zones.

3. The system of claim 2 wherein the geolocation system updates the database with respect to linking individuals to zones by tracking and communicating with wireless devices held by the individual and identifying a zone in which the individual is traveling.

4. The system of claim 2 wherein the individual descriptors include gender, age, and purchasing preferences.

5. The system of claim 2 wherein the individual descriptors include a historical list of venues visited by the individuals.

6. The system of claim 2 wherein the content server further analyzes individual descriptors of individuals in given zones to augment the context for the zones based on a historical aggravation of individual descriptors of individuals within given zones.

7. The system of claim 1 wherein the database includes individual permissions linked to the individuals describing, each individual's preferences with regard to sharing of the individual descriptors and wherein the matching of campaigns to venues and zones is limited according to the individual permissions.

8. The system of claim 7 wherein the individual permissions include restrictions on sharing together types of individual descriptors.

9. The system of claim 7 wherein individual permissions include restrictions on a frequency of delivery of content.

10. The system of claim 1 wherein the content server prioritizes campaigns according to a weighting quantifying a matching of individual characteristics.

11. The system of claim 1 wherein the database includes venue permissions linked to the venues describing each venue's preferences with regard to the delivery of content and wherein the matching of campaigns to venues and zones is limited according to the venue permissions.

12. The system of claim 1 wherein the venue permissions include restrictions on type of content to be delivered to the venue.

13. The system of claim 1 wherein the venue permissions include restrictions on an amount of content to be delivered to individuals.

14. The system of claim 1 wherein the database further provides a listing of entities controlling the zones and wherein the content server provides a payment credit to the entities of the identified zones upon delivery of content selectively to individuals in the identified zones.

15. The system of claim 1 wherein the multiplicity of venues includes different retail establishments and wherein the zones provide for different departments clustering similar merchandise.

16. The system of claim 1 wherein the content server prioritizes campaigns according to a weighting quantifying a matching of desired contexts of the campaign to context of the zone.
